(19) United States
(12) Patent Application Publication
(10) Pub. No.: US 2023/0070913 A1
(43) Pub. Date: Mar. 9, 2023

(54) COMMUNICATION DEVICE, COMMUNICATION SYSTEM, AND COMMUNICATION METHOD

(71) Applicant: Sony Semiconductor Solutions Corporation, Kanagawa (JP)

(72) Inventors: Hiroaki Nakano, Tokyo (JP); Kohei Yamamoto, Tokyo (JP)

(21) Appl. No.: 17/796,754

(22) PCT Filed: Mar. 18, 2021
(86) PCT No.: PCT/JP2021/011254

§ 371 Date: Aug. 1, 2022

(30) Foreign Application Priority Data
Mar. 25, 2020 (JP) 2020-054816

(51) Int. Cl. G01S 5/14; G01S 5/02

(52) U.S. Cl. CPC G01S 5/14; G01S 5/02524

(57) ABSTRACT

To acquire distance information with high accuracy with a simple configuration, and perform highly reliable positioning.

A communication device includes a distance acquisition unit that acquires distance information calculated on the basis of a propagation channel characteristic, and an altitude acquisition unit that acquires altitude information.

### TECHNICAL FIELD

The present disclosure relates to a communication device, a communication system, and a communication method.

### BACKGROUND ART

In recent years, indoor positioning technology has attracted attention. Since radio waves from satellites do not reach indoors, there is a problem that signals from a global positioning system (GPS) or a global navigation satellite system (GNSS) cannot be received, and various methods have been proposed. For example, there are pedestrian dead reckoning (PDR) in which a motion and a movement amount of a user are measured by a plurality of sensors such as an acceleration sensor and a gyro sensor, a method of estimating a position by collation of geomagnetic data, a method of estimating a distance by a flight time (ToF) from when light is projected to when light is received, and the like.

### CITATION LIST

### Patent Document

Patent Document 1: Japanese Patent Application Laid-Open No. 2011-17685
Patent Document 2: Japanese Patent Application Laid-Open No. 2017-67565

### SUMMARY OF THE INVENTION

### Problems to be Solved by the Invention

However, for example, in the PDR method, a distance measurement error is accumulated, but there is no means for correcting the distance measurement error. In addition, in a method that requires data collation of geomagnetic data or the like, it is essential to create a preliminary map, and there is a large problem in terms of operation, for example, it is necessary to recreate collation data again when the layout is changed or the map is changed. The ToF method is affected by shadowing (a decrease in distance measurement performance due to a human body), and has a problem that a correct distance cannot be measured unless the environment is a line-of-sight environment.

In order to solve the problems, a distance measurement method using a wireless signal has attracted attention. This is because many wireless communication ICs such as Bluetooth low energy (BLE), Wi-Fi, and long term evolution (LTE) are already built in a smartphone, and preliminary learning and the like are unnecessary, and development into an application is facilitated. However, the distance measurement method using a wireless signal has a problem that the distance measurement accuracy is low.

Currently, a method of using a received signal strength Indicator (RSSI) is being commercialized as a solution. This is a method of determining that a signal is close if the signal is large and is far if the signal is small, but it is known that the signal is likely to be affected by multipath (reflected wave). In addition, there is a problem that a large error is generated in received signal strength depending on the angle of an antenna.

Therefore, the present disclosure provides a communication device, a communication system, and a communication method capable of acquiring distance information with high accuracy with a simple configuration and performing highly reliable positioning.

### Solutions to Problems

In order to solve the above problem, the present disclosure provides a communication device including a distance acquisition unit that acquires distance information calculated on the basis of a propagation channel characteristic, and

an altitude acquisition unit that acquires altitude information.

A communication unit that transmits the distance information and the altitude information to a processing device may further be included.

The distance acquisition unit may acquire the distance information calculated from a relationship between each frequency and each phase of a plurality of propagation channels.

The distance acquisition unit may directly acquire the distance information from a measured phase calculated on the basis of a group delay calculated from a relationship between each frequency and each phase of a plurality of propagation channels.

The distance acquisition unit may acquire the distance information on the basis of a wireless signal in an ultra wideband (UWB) band.

The altitude acquisition unit may acquire the altitude information on the basis of an atmospheric pressure detected by an atmospheric pressure sensor.

The altitude acquisition unit may acquire the altitude information on the basis of an atmospheric pressure detected by the atmospheric pressure sensor and a temperature detected by a temperature sensor.

The present disclosure provides a processing device including a distance acquisition unit that acquires a plurality of pieces of distance information calculated from a relationship between each frequency and each phase of a plurality of propagation channels,

an altitude acquisition unit that acquires altitude information through communication, and

a position detection unit that detects position information on the basis of the distance information and the altitude information.

The distance acquisition unit may acquire three or more pieces of the distance information related to distances between an object and three or more communication partner devices, and

the position detection unit may detect a position of the object on the basis of the three or more pieces of distance information and the altitude information.

The altitude acquisition unit may acquire three or more pieces of the altitude information from the three or more communication partner devices, and

the position detection unit may detect a position of the object on the basis of the three or more pieces of distance information and the three or more pieces of altitude information.

By the object transmitting and receiving wireless signals of a plurality of frequencies to and from the three or more communication partner devices to calculate a phase, the distance acquisition unit may calculate distance information with the three or more communication partner devices in the object, and

the position detection unit may detect a position of the object on the basis of three or more pieces of the distance information calculated by the distance acquisition unit and the three or more pieces of altitude information.

The distance acquisition unit may acquire the three or more pieces of distance information calculated in the three or more communication partner devices by the object communicating with the three or more communication partner devices, and the position detection unit may detect a position of the object on the basis of the three or more pieces of distance information acquired by the distance acquisition unit and the three or more pieces of altitude information.

The position detection unit may create a three-dimensional map indicating position information in a predetermined three-dimensional space on the basis of the distance information.

The distance acquisition unit may acquire three or more pieces of the distance information between an object and three or more communication partner devices, and

the position detection unit may create the three-dimensional map on the basis of the three or more pieces of distance information.

The three-dimensional map may include position information of the object and the three or more communication partner devices.

The distance acquisition unit may acquire three or more pieces of the distance information related to distances between an object and three or more communication partner devices,

the altitude acquisition unit may acquire three or more pieces of the altitude information from the three or more communication partner devices, and the position detection unit may create the three-dimensional map on the basis of the three or more pieces of distance information and the three or more pieces of altitude information.

The present disclosure provides a processing device including a distance acquisition unit that acquires a plurality of pieces of distance information calculated from a relationship between each frequency and each phase of a plurality of propagation channels,

a position acquisition unit that acquires absolute position information of at least one point, and

a position detection unit that detects position information on the basis of the plurality of pieces of distance information and absolute position information acquired by the position acquisition unit.

The position acquisition unit may acquire the absolute position information regularly or irregularly, and

the position detection unit may update the position information on the basis of the absolute position information regularly or irregularly acquired by the position acquisition unit.

An altitude acquisition unit that acquires altitude information through communication may further be included, in which

the position detection unit may detect the position information on the basis of the plurality of pieces of distance information, the absolute position information, and the altitude information.

The altitude information may include altitude difference information related to an altitude difference between two points, and

a reliability estimation unit that estimates reliability of the distance information on the basis of the distance information and the altitude difference information may further included.

A position acquisition unit that acquires absolute position information of at least one point may further be included.

The position acquisition unit may acquire global positioning system (GPS) information.

The present disclosure provides a communication system including

a first communication device,

a second communication device that transmits and receives a wireless signal to and from the first communication device,

a distance acquisition unit that acquires distance information calculated on the basis of a propagation channel characteristic,

an altitude acquisition unit that acquires altitude information, and

a position detection unit that detects position information on the basis of the distance information and the altitude information.

A third communication device that transmits and receives a wireless signal to and from the second communication device may further be included, in which

the second communication device may include the distance acquisition unit and the altitude acquisition unit,

the third communication device may include the position detection unit,

the distance acquisition unit may acquire the distance information with the first communication device, and

the position detection unit may detect the position information on the basis of the distance information and the altitude information.

The present disclosure provides a communication method including acquiring distance information calculated on the basis of a propagation channel characteristic,

acquiring altitude information, and

detecting position information on the basis of the distance information and the altitude information.

### BRIEF DESCRIPTION OF DRAWINGS

FIG. 1 is a block diagram illustrating a configuration of a main part of a communication device 1 according to a first embodiment.

FIG. 2 is a block diagram illustrating the communication device 1 according to the first embodiment more specifically than FIG. 1.

FIG. 3 is a diagram for explaining an outline of a phase-based method.

FIG. 4 is a block diagram illustrating an example of an internal configuration of an initiator 11 and a reflector 12 in accordance with the phase-based method.

FIG. 5 is a diagram illustrating an example of a signal sequence transmitted and received between the initiator 11 and the reflector 12 in accordance with the phase-based method.

FIG. 6A is a configuration diagram of a packet transmitted from the initiator 11 at the time of phase measurement.

FIG. 6B is a packet configuration diagram according to a modification of FIG. 6A.

FIG. 6C is a packet configuration diagram at the start of data communication.

FIG. 7 is a diagram illustrating an example in which a transmission signal cos ωt converted into an intermediate frequency signal with a local oscillation signal is transmitted from an initiator to a reflector.

FIG. 8 is a diagram illustrating an example in which a transmission signal converted into an intermediate frequency signal with a local oscillation signal is transmitted from the reflector to the initiator.

FIG. 9 is a diagram illustrating an example of adding a measured phase of the reflector in FIG. 7 and a measured phase of the initiator in FIG. 8.

FIG. 10 is a diagram illustrating transmission and reception of a signal in a communication system according to the first embodiment.

FIG. 11 is a flowchart illustrating a processing operation of a device.

FIG. 12A is a diagram illustrating transmission and reception of a signal in a communication system according to a second embodiment.

FIG. 12B is a diagram illustrating transmission and reception of a signal in the communication system according to the second embodiment.

FIG. 13 is a block diagram illustrating a schematic configuration of a processing device according to a third embodiment.

FIG. 14A is a diagram illustrating transmission and reception of a signal in a communication system according to the third embodiment.

FIG. 14B is a diagram illustrating transmission and reception of a signal in the communication system according to the third embodiment.

FIG. 15 is a flowchart illustrating a processing operation of a processing device 31 such as a server in FIG. 14B.

FIG. 16 is a plan layout view illustrating an example in which beacon devices are installed at a plurality of locations in a room.

FIG. 17 is a flowchart illustrating a first example of a processing operation of a communication system according to a fourth embodiment.

FIG. 18 is a diagram illustrating an example in which a reference beacon device is installed near a window to acquire absolute position information.

FIG. 19 is a flowchart illustrating a second example of the processing operation of the communication system according to the fourth embodiment.

FIG. 20A is a diagram illustrating an example in which a device dv1 and a device dv2 are provided at the same altitude. FIG. 20B is a diagram illustrating an example in which altitudes of the device dv1 and the device dv2 are different.

FIG. 21 is a flowchart illustrating a first example of a processing operation of a communication system according to a fifth embodiment.

FIG. 22 is a flowchart illustrating a second example of the processing operation of the communication system according to the fifth embodiment.

### MODE FOR CARRYING OUT THE INVENTION

Hereinafter, embodiments of a communication device, a communication system, and a communication method will be described with reference to the drawings. Although main components of the communication device and the communication system will be mainly described below, the communication device and the communication system may have components and functions that are not illustrated or described. The following description does not exclude the components and functions that are not illustrated or described.

### First Embodiment

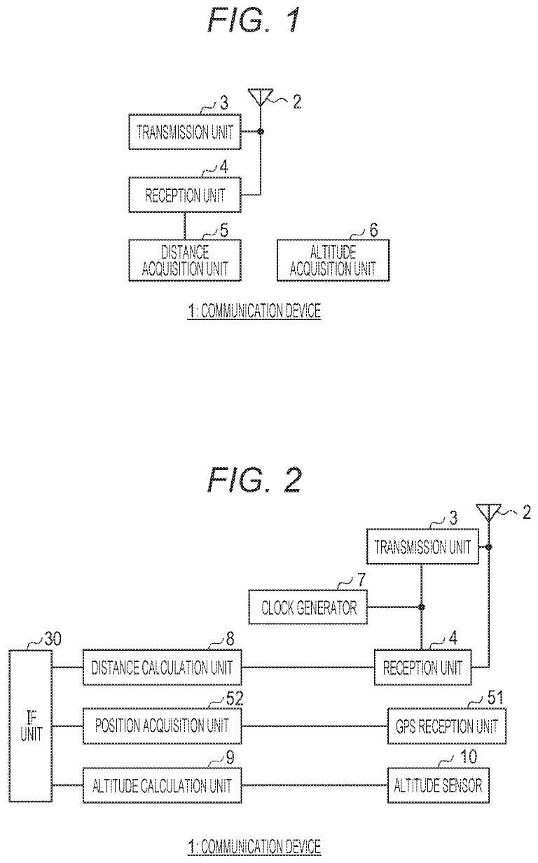

FIG. 1 is a block diagram illustrating a configuration of a main part of a communication device 1 according to a first embodiment. The communication device 1 in FIG. 1 includes an antenna 2, a transmission unit 3, a reception unit 4, a distance acquisition unit 5, and an altitude acquisition unit 6. In this specification, the transmission unit 3 and the reception unit 4 may be collectively referred to as “communication unit”.

The distance acquisition unit 5 acquires distance information calculated on the basis of propagation channel characteristics. The propagation channel characteristics refer to characteristics during propagation of a wireless signal through a propagation path, and include, for example, a phase difference generated during the propagation through the propagation path. The distance acquisition unit 5 may calculate the distance information inside the communication device 1 of FIG. 1 or may acquire the distance information via the reception unit 4. The distance acquisition unit 5 acquires, for example, distance information calculated from a relationship between each frequency and each phase of a plurality of propagation channels. Alternatively, the distance acquisition unit 5 may directly acquire the distance information from a measured phase calculated on the basis of a group delay calculated from the relationship between each frequency and each phase of the plurality of propagation channels.

The altitude acquisition unit 6 acquires altitude information. The altitude acquisition unit 6 may acquire altitude information detected by an altitude sensor provided in the communication device 1 of FIG. 1, for example. The altitude sensor may be an atmospheric pressure sensor, and the altitude acquisition unit 6 may acquire the altitude information on the basis of the atmospheric pressure detected by the atmospheric pressure sensor. Alternatively, the altitude acquisition unit 6 may acquire the altitude information on the basis of the atmospheric pressure detected by the atmospheric pressure sensor and a temperature detected by a temperature sensor. Alternatively, the altitude acquisition unit 6 may acquire altitude information of a communication partner device via the reception unit 4.

The communication device 1 of FIG. 1 may perform various types of information processing on the basis of the distance information acquired by the distance acquisition unit 5 and the altitude information acquired by the altitude acquisition unit 6, or may transmit the distance information and the altitude information to a processing device such as a server via the transmission unit 3.

FIG. 2 is a block diagram illustrating the communication device 1 according to the first embodiment more specifically than FIG. 1. The communication device 1 of FIG. 2 includes the antenna 2, the transmission unit 3, the reception unit 4, a clock generator 7, a distance calculation unit 8, an altitude calculation unit 9, an altitude sensor 10, and an interface (IF) unit 30.

The clock generator 7 includes a local oscillator that generates a local oscillation signal used for a modulation process in the transmission unit 3 and a demodulation process in the reception unit 4.

The distance calculation unit 8 calculates distance information on the basis of the propagation channel characteristics. For example, the distance calculation unit 8 may calculate the distance information by, for example, a phase-based method or an ultra wideband (UWB) method. Details of the phase-based method and the UWB method will be described later. The distance calculation unit 8 has the function of the distance acquisition unit 5 in FIG. 1.

The altitude calculation unit 9 calculates altitude information on the basis of a signal detected by the altitude sensor 10. The altitude calculation unit 9 has the function of the altitude acquisition unit 6 in FIG. 1. The altitude sensor 10 may be, for example, an atmospheric pressure sensor. Since the atmospheric pressure changes depending on the height, the altitude information can be calculated from a detection signal of the atmospheric pressure sensor. Since the atmospheric pressure is affected by the temperature, by including not only the atmospheric pressure sensor but also the temperature sensor as the altitude sensor 10, the altitude calculation unit 9 can correct the atmospheric pressure detected by the atmospheric pressure sensor in accordance with the temperature detected by the temperature sensor. The interface unit 30 inputs and outputs various signals.

The communication device 1 of FIG. 2 may include a global positioning system (GPS) reception unit 51 and a position acquisition unit 52. The GPS reception unit 51 receives a GPS signal from a GPS satellite. The position acquisition unit 52 acquires absolute position information of at least one point on the basis of the GPS signal received.

The communication device 1 of FIG. 1 may be a portable communication device such as a smartphone or a mobile phone, a beacon device installed in a predetermined place, or a wireless station such as a base station or a server that performs wireless communication with the portable communication device, the beacon device, or the like.

The communication device 1 of FIG. 1 performs wireless communication with a communication partner device to calculate distance information with the communication partner device on the basis of the propagation channel characteristics. Hereinafter, as a specific example of the propagation channel characteristics, a method of calculating distance information with a communication partner device by the phase-based method will be described.

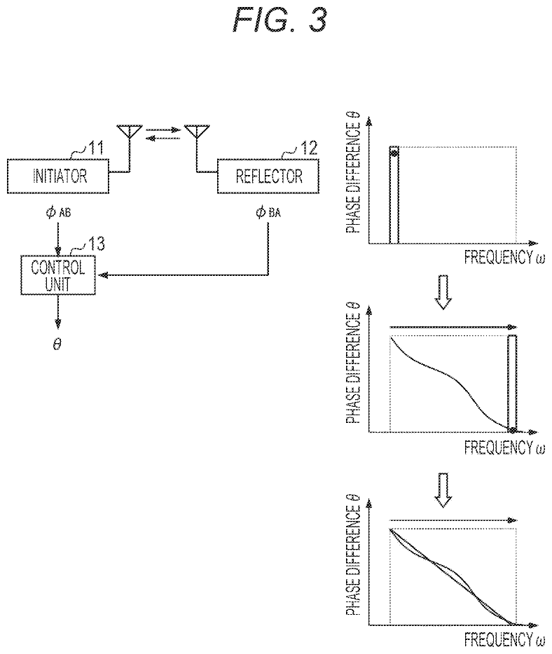

FIG. 3 is a diagram for explaining an outline of the phase-based method. In the phase-based method, a wireless signal is transmitted and received between an initiator 11 and a reflector 12 to estimate a phase difference of a propagation path between the initiator 11 and the reflector 12. The initiator 11 and the reflector 12 have a configuration similar to, for example, that of the communication device 1 in FIG. 1 or 2.

FIG. 3 is a diagram illustrating the phase-based method. An example is illustrated in which a wireless signal in a frequency band of 2.4 GHz is transmitted and received between the initiator 11 and the reflector 12, and a phase difference θ of a transmission path is measured by a control unit 13. As illustrated in FIG. 3, when the horizontal axis represents a frequency ω and the vertical axis represents the phase difference θ, the phase difference θ changes substantially linearly in accordance with the frequency. A group delay τ can be calculated from the slope of the phase difference. The group delay τ is obtained by differentiating the phase difference θ between an input waveform and an output waveform with an angular frequency ω. Since it is impossible to distinguish a phase from a phase shifted by an integral multiple of 2π, a group delay is used as an index indicating characteristics of a filter circuit.

Assuming that the phase difference between a transmission signal and a reception signal is θd, the measured phase is θm, the distance of the propagation path is D, and the speed of light is c, the following equation (1) is established.

θd(=θm+2πn)=ωtd=ω×2D/c (1)

When both sides of Equation (1) are differentiated by the angular frequency ω, Equation (2) is obtained.

$$[ Formula 1 ]$$

$$\frac{d {θ}_{d}}{d ω} = \frac{d {θ}_{m}}{d ω} = \frac{2 D}{c} \qquad ( 2 )$$

When Equation (2) is transformed, the distance D is obtained by the following Equation (3).

$$[ Formula 2 ]$$

$$D = \frac{c}{2} \times \frac{d {θ}_{m}}{d ω} \qquad ( 3 )$$

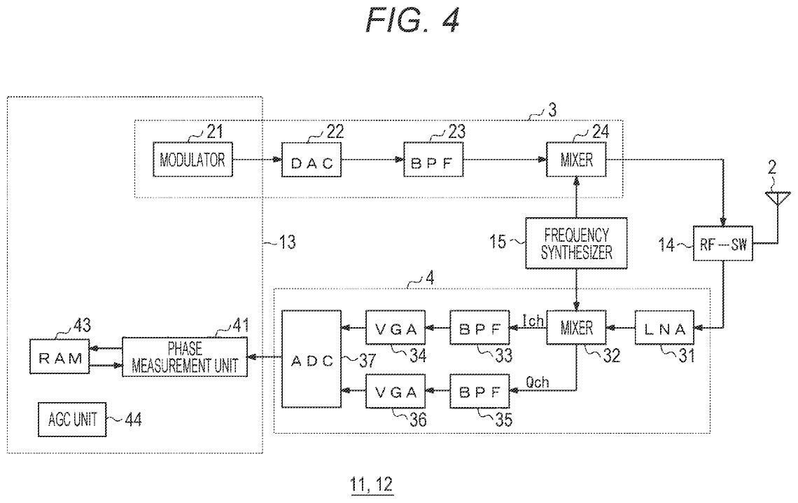

FIG. 4 is a block diagram illustrating an example of an internal configuration of the initiator 11 and the reflector 12 in accordance with the phase-based method. The initiator 11 and the reflector 12 have the same internal configuration. The initiator 11 and the reflector 12 in FIG. 4 include the antenna 2, the transmission unit 3, the reception unit 4, and the control unit 13. The transmission signal output from the transmission unit 3 and the reception signal received by the antenna 2 are switched by a radio frequency switch (RF-SW) 14. The transmission unit 3 and the reception unit 4 perform a modulation process and a demodulation process in synchronization with a clock output from a frequency synthesizer 15.

The transmission unit 3 includes a modulator 21 in the control unit 13, a DA converter (DAC) 22, a band pass filter (BPF) 23, and a mixer 24. The reception unit 4 includes a low noise amplifier (LNA) 31, a mixer 32, a band pass filter (BPF) 33 and a variable gain amplifier (VGA) 34 for an I channel, a BPF 35 and a VGA 36 for a Q channel, and an AD converter (ADC) 37.

The control unit 13 includes the modulator 21, a phase measurement unit 41, a RAM 43, and an automatic gain control unit (AGC) 44.

After the phase measurement unit 41 measures the phase difference between the transmission signal and the reception signal for each frequency channel, the digital demodulation signal output from the reception unit 4 is stored in the RAM 43. The phase measurement unit 41 may perform digital signal processing such as averaging, filtering, and FFT.

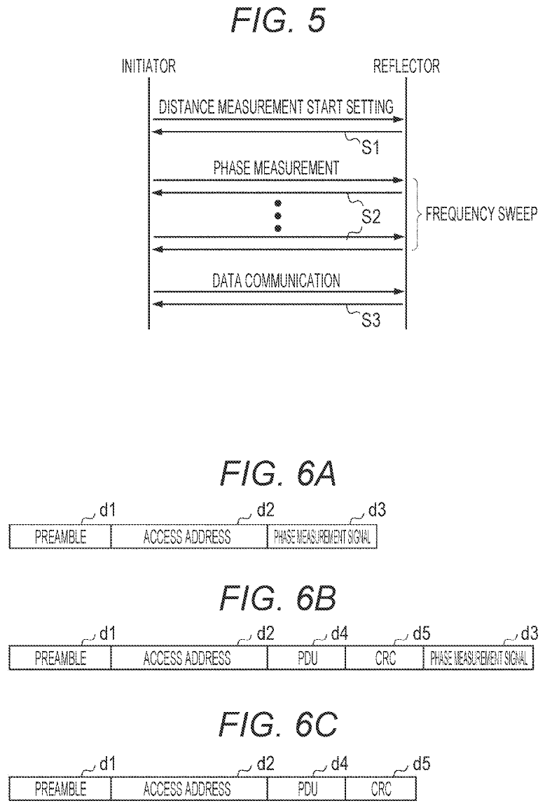

FIG. 5 is a diagram illustrating an example of a signal sequence transmitted and received between the initiator 11 and the reflector 12 in accordance with the phase-based method. First, setting for starting distance measurement is performed (step S1). In step S1, for example, device authentication as to whether or not a device is compliant with Bluetooth Low Energy (BLE), negotiation, frequency offset correction, AGC gain setting, and the like are performed. In the negotiation, whether or not the device is a device capable of distance measurement is checked, distance measurement setting parameters are checked, and the like.

Next, for example, the frequency is swept in the range of 2400 MHz to 2480 MHz used by the BLE, and phase measurement is performed for each frequency channel to calculate distance information (step S2). When the distance information is calculated in step S2, data communication is then performed between the initiator 11 and the reflector 12 (step S3), and data including the distance information and altitude information is transmitted and received.

FIGS. 6A, 6B, and 6C are specific examples of packets transmitted and received by the initiator 11 and the reflector 12 in accordance with the phase-based method. FIG. 6A is a configuration diagram of a packet transmitted from the initiator 11 at the time of phase measurement. FIG. 6B is a packet configuration diagram according to a modification of FIG. 6A. FIG. 6C is a packet configuration diagram at the start of data communication.

The packet in FIG. 6A includes a preamble d1, an access address d2, and a phase measurement signal d3. The phase measurement signal d3 is a single carrier signal. The packet in FIG. 6B includes a protocol data unit (PDU) d4 and a cyclic redundancy check (CRC) d5 in addition to the packet configuration of FIG. 6A. The packet in FIG. 6C includes the preamble d1, the access address d2, the PDU d4, and the CRC d5. Note that FIGS. 6A to 6C are examples of the packet configuration, and various modifications are conceivable.

As illustrated in FIGS. 6A and 6B, the initiator 11 transmits a single carrier signal to the reflector 12, but it is impossible to correctly detect the phase difference of a propagation path only in one direction from the initiator 11 to the reflector 12 due to the influence of a local phase. Therefore, in the phase-based method, a process of canceling the local phase by reciprocating signals between the initiator 11 and the reflector 12 is performed.

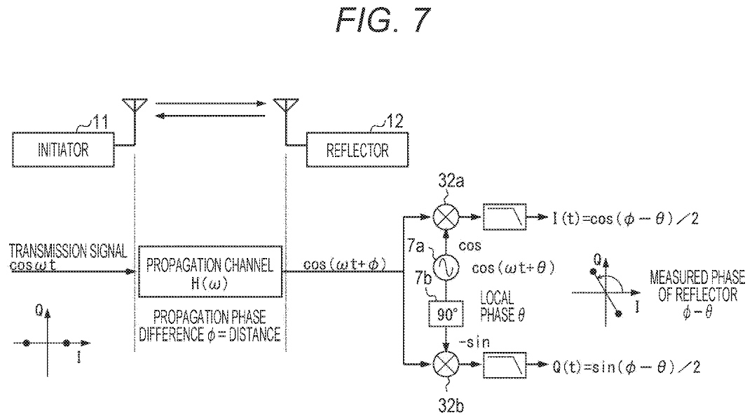

FIGS. 7 to 9 are diagrams for explaining a method of canceling a local phase. As illustrated in FIGS. 7 to 9, the frequency synthesizer 15 of FIG. 4 includes a local oscillator 7a and a 90-degree phase shifter 7b. FIG. 7 is a diagram illustrating an example in which a transmission signal cos ωt converted into an intermediate frequency signal with a local oscillation signal is transmitted from the initiator 11 to the reflector 12. In FIG. 7, the phase difference at which a transmission signal propagates through a propagation path is represented by φ. In this case, the reflector 12 receives a signal cos(ωt+p). Assuming that the local oscillator 7a in the reflector 12 has the local phase θ, the local oscillation signal is represented by cos (ωt+φ). Therefore, an I signal generated by the reflector 12 is represented by I(t)=cos (φ−θ)/2, and a Q signal is represented by Q(t)=sin (φ−θ)/2.

The measured phase of the reflector 12 is thus φ−θ. This measured phase can be detected by an arithmetic unit or the like provided in the reflector 12. This arithmetic unit is built in, for example, an integrated circuit (IC) chip that performs the function of the reflector 12.

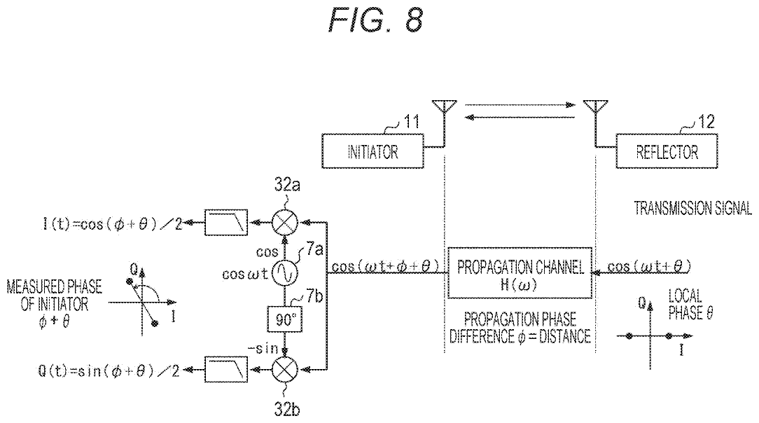

FIG. 8 is a diagram illustrating an example in which a transmission signal cos (ωt+θ) converted into an intermediate frequency signal with a local oscillation signal is transmitted from the reflector 12 to the initiator 11. As described above, e is a local phase of the local oscillator 7a in the reflector 12. In this case, the initiator 11 receives a signal cos(ωt+φ+θ). Therefore, the I signal generated by the initiator 11 is represented by I(t)=cos(φ+θ)/2, and the Q signal is represented by Q(t)=sin(φ+θ)/2.

The measured phase of the initiator 11 is thus φ+θ. This measured phase can be detected by an arithmetic unit or the like provided in the initiator 11. This arithmetic unit is built in, for example, an IC chip that performs the function of the initiator 11.

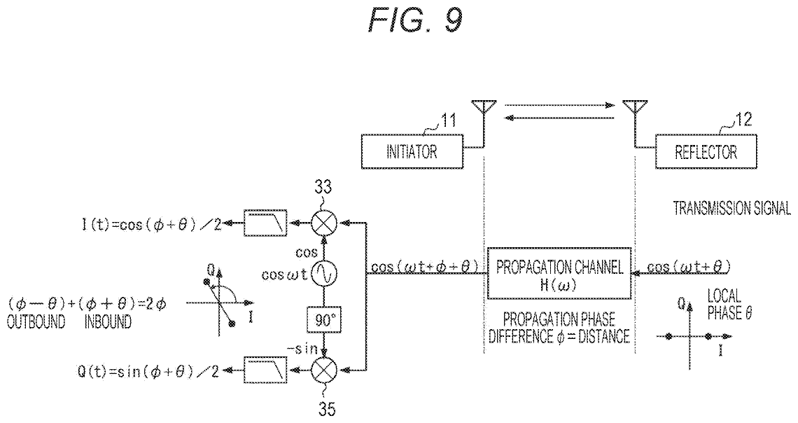

FIG. 9 illustrates an example of adding the measured phase (φ−θ) of the reflector 12 in FIG. 7 and the measured phase (φ+θ) of the initiator 11 in FIG. 8. (φ−θ)+(φ+θ)=2φ, and it can be seen that the influence of the local phase can be canceled. This addition operation can be performed by an arithmetic unit or the like in the IC chip for the reflector 12 or the initiator 11 described above.

By reciprocating signals between the initiator 11 and the reflector 12 as described above, it is possible to detect the phase difference of the transmission path without being affected by the local phase 9. If the phase difference of the propagation path can be detected, the distance of the propagation path can be calculated by Equations (1) to (3) described above.

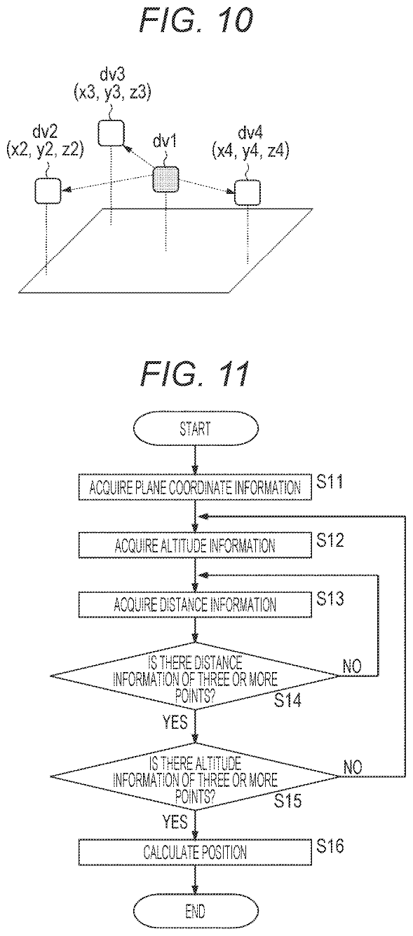

FIG. 10 is a diagram illustrating transmission and reception of a signal in a communication system according to the first embodiment. A device dv1 in FIG. 10 is, for example, a portable communication device such as a smartphone, and devices dv2 to dv4 are, for example, beacon devices installed in predetermined places. Each of the devices dv1 to dv4 has a configuration similar to that of the communication device 1 in FIG. 2, for example. In the example of FIG. 10, in response to a request from the device dv1, the devices dv2 to dv4 transmit information for calculating a distance, their own coordinates, and altitude information to the device dv1.

The information for calculating a distance is, for example, a single carrier signal. By the device dv1 transmitting a single carrier signal to each of the devices dv2 to dv4 and the devices dv2 to dv4 returning the same signal to the device dv1, as described above, the device dv1 can calculate distance information with each of the devices dv2 to dv4. In addition, the devices dv2 to dv4 transmit own coordinate information and the altitude information to the device dv1. As a result, the device dv1 can perform positioning with high accuracy regardless of the height of the device dv1 on the basis of the distance information with each of the devices dv2 to dv4 and the altitude information of each of the devices dv2 to dv4.

FIG. 11 is a flowchart illustrating a processing operation of the device dv1. First, plane coordinate information of the devices dv2 to dv4 is acquired (step S11). In step S11, own coordinate information of each device transmitted from each of the devices dv2 to dv4 is acquired.

Next, altitude information of each of the devices dv1 to dv4 is acquired (step S12). If the device dv1 includes the altitude sensor 10, the device dv1 acquires altitude information by the altitude sensor 10. Alternatively, the altitude information transmitted from the devices dv2 to dv4 is acquired.

Next, distance information between the device dv1 and the devices dv2 to dv4 is acquired (step S13). As described above, for example, the distance information can be calculated by reciprocating signals between the device dv1 and the devices dv2 to dv4 for each frequency channel by the phase-based method. Note that the distance information is not necessarily calculated by the device dv1, and the device dv1 may acquire a result of calculation of the distance information with the device dv1 by each of the devices dv2 to dv4.

Next, it is determined whether or not there is distance information of three or more points (step S14). In order to specify the position of the device dv1, it is necessary to measure distances to three or more other devices around the device dv1. Therefore, in step S14, it is determined whether or not there is distance information of three or more points, and if there is no distance information, the process returns to step S13 to acquire new distance information.

If it is determined in step S14 that there is distance information of three or more points, it is determined whether or not there is altitude information of three or more points (step S15). By including the altitude information at the time of detecting the position of the device dv1, it is possible to obtain a benefit of improving the position detection accuracy more than a case where the number of pieces of distance information is simply increased by one. In indoor positioning, highly reliable distance measurement is not always possible due to the influence of multipath or the like in which a wireless signal is reflected by a peripheral metal member or the like. On the other hand, the altitude sensor 10 such as an atmospheric pressure sensor has high detection accuracy, and can reliably detect altitude information even in a multipath environment. Therefore, the position detection accuracy can be improved by performing position detection using the altitude information. In addition, since the position detection accuracy increases as the number of pieces of altitude information increases, in step S15, it is determined whether or not there is altitude information of three or more points. If there is only altitude information of less than three points, the process returns to step S12 to acquire new altitude information. If there is altitude information of three or more points, the position of the device dv1 is detected (step 16), and the process of FIG. 11 ends.

As described above, in the first embodiment, since the device dv1 acquires the information for calculating a distance, the own coordinate information, and the altitude information from the surrounding devices dv2 to dv4, the distance information with each of the devices dv2 to dv4 can be calculated on the basis of the propagation channel characteristics, and the position of the device dv1 can be accurately detected on the basis of the coordinate information and the altitude information of the devices dv2 to dv4.

### Second Embodiment

In a second embodiment, the position of the device dv1 is calculated by a processing device such as a server. The second embodiment is mainly assumed for traffic line analysis in a factory, grasping a position of a robot, and the like.

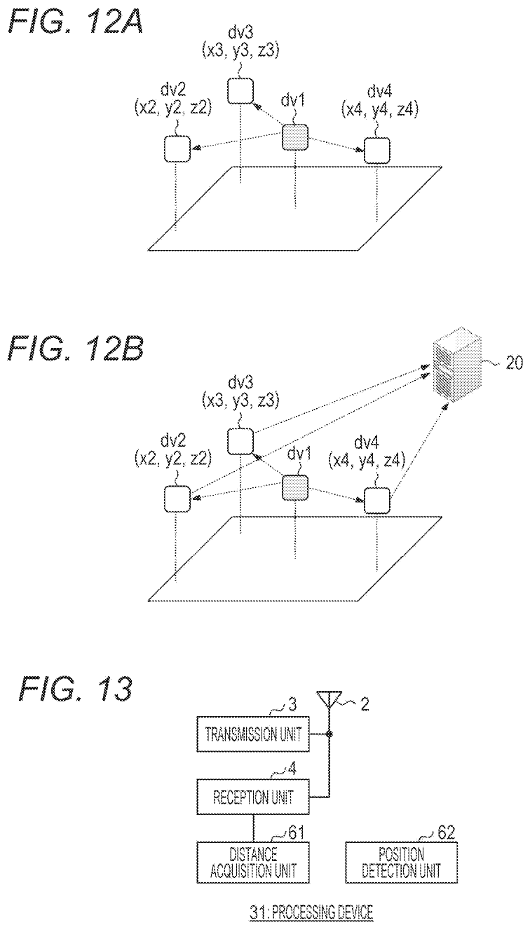

FIGS. 12A and 12B are diagrams illustrating transmission and reception of a signal in a communication system according to the second embodiment. The device dv1 in FIGS. 12A and 12B is a beacon device installed in a moving object such as a specific person or machine, and the devices dv2 to dv4 are the communication device 1 having a communication function with a beacon device or a server (a processing device) installed in each place. The devices dv1 to dv4 have, for example, a configuration similar to that of FIG. 2.

First, as illustrated in FIG. 12A, in response to requests from the devices dv2 to dv4, the device dv1 transmits information for calculating a distance to the devices dv2 to dv4. The information for calculating a distance is, for example, a single carrier signal as described above. In addition, if the device dv1 has the altitude sensor 10, the altitude information measured by the altitude sensor 10 may be included in the information for calculating a distance and transmitted to the devices dv2 to dv4.

The devices dv2 to dv4 calculate distance information with the device dv1 on the basis of the propagation channel characteristics described above. Then, as illustrated in FIG. 12B, the devices dv2 to dv4 transmit the distance information calculated, own coordinate information, and the altitude information acquired by the altitude sensor 10 to a processing device 20 such as a server. The processing device 20 calculates the position of the device dv1 on the basis of the distance information, the own coordinate information, and the altitude information transmitted from the devices dv2 to dv4.

FIGS. 12A and 12B illustrate an example in which the position of the device dv1 is calculated using the devices dv2 to dv4 around the device dv1. However, even in a case where there is a plurality of devices dv1, the positions of the plurality of devices dv1 can be calculated by the processing procedure described above using a plurality of devices around each device dv1.

Note that a specific form of the processing device 20 is not limited. The processing device 20 is only required to include the communication function with the devices dv2 to dv4 and processing performance for calculating the position of the device dv1, and may be a server, a PC, a tablet, or the like.

As described above, in the second embodiment, the information for calculating a distance is transmitted from the device dv1 to the devices dv2 to dv4, the distance information with the device dv1 is calculated by the devices dv2 to dv4, the distance information, the own coordinate information, and the altitude information are transmitted from the devices dv2 to dv4 to the server, and the position of the device dv1 is calculated by the processing device 20. As a result, the position of the device dv1 can be managed by the processing device 20 such as a server. In addition, even if the device dv1 does not have processing performance for calculating a position, the processing device 20 can accurately calculate the position of the device dv1.

### Third Embodiment

In a third embodiment, a plurality of devices mutually transmits and receives signals, calculates mutual distance information, and transmits the distance information calculated to the processing device 20 such as a server.

FIG. 13 is a block diagram illustrating a schematic configuration of the processing device 20 according to the third embodiment. The communication device 1 in FIG. 13 includes the antenna 2, the transmission unit 3, the reception unit 4, a distance acquisition unit 61, and a position detection unit 62.

The distance acquisition unit 61 acquires distance information calculated by a communication partner device on the basis of propagation channel characteristics by transmitting and receiving signals to and from the communication partner device. The communication partner device calculates distance information with another communication partner device on the basis of the propagation channel characteristics by reciprocating signals between the communication partner device and another communication partner device. The position detection unit 62 detects position information on the basis of the distance information acquired by the distance acquisition unit 61. The processing device 20 of FIG. 13 may include the altitude sensor 10.

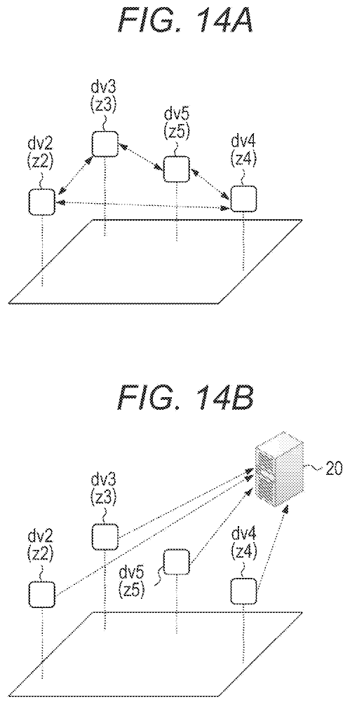

FIGS. 14A and 14B are diagrams illustrating transmission and reception of a signal in a communication system according to the third embodiment. Devices dv2 to dv5 are, for example, beacon devices, and have a configuration similar to that of the communication device 1 in FIG. 2. Hereinafter, an example in which each of the devices dv2 to dv5 includes the altitude sensor 10 will be described. Each of the devices dv2 to dv5 does not need to grasp the absolute coordinates. First, as illustrated in FIG. 14A, the devices dv2 to dv5 calculate distance information on the basis of the propagation channel characteristics by reciprocating signals between the devices. As a result, each of the devices dv2 to dv5 can calculate the relative coordinates.

Next, as illustrated in FIG. 14B, the devices dv2 to dv5 transmit the distance information calculated and altitude information to the processing device 20 such as a server. The processing device 20 has the configuration of FIG. 13, and can create a relative position map of the devices dv2 to dv5 on the basis of the distance information and the altitude information transmitted from the devices dv2 to dv5.

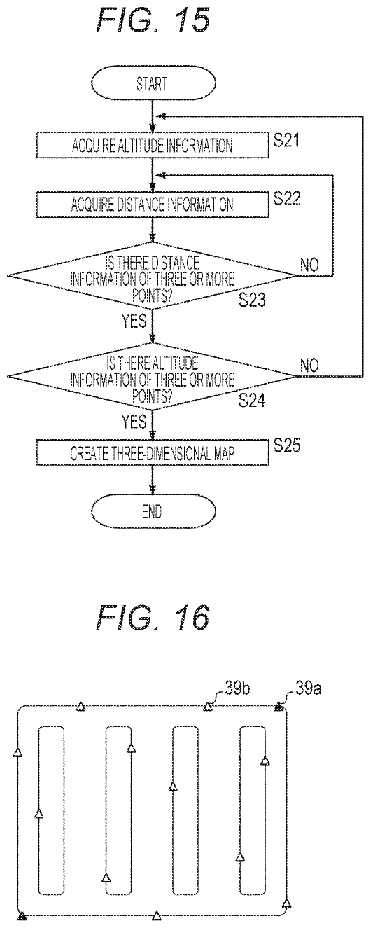

FIG. 15 is a flowchart illustrating a processing operation of the processing device 20 such as a server in FIG. 14B. First, the processing device 20 acquires the altitude information transmitted from the devices dv2 to dv5 (step S21) and acquires distance information (step S22).

Next, the processing device 20 determines whether or not distance information of three or more points has been acquired (step S23), and if only distance information of less than three points has been acquired, processes of step S22 and subsequent steps are performed. If it is determined that the distance information of three or more points has been acquired, the processing device 20 determines whether or not altitude information of three or more points has been acquired (step S24). If only distance information of less than three points has been acquired, processes of step S21 and subsequent steps are performed. If it is determined that the distance information of three or more points has been acquired, the processing device 20 creates a three-dimensional map (step S25).

The three-dimensional map is a map including relative position information of the devices dv2 to dv5. Note that, as will be described later, in a case where the processing device 20 can acquire one or more absolute position (coordinate) coordinates, the processing device can create a three-dimensional map including absolute position (coordinate) information of the devices dv2 to dv5.

As described above, in the third embodiment, by reciprocating signals between the devices dv2 to dv5, the individual devices can calculate relative distance information on the basis of the propagation channel characteristics. In addition, by transmitting the distance information and the altitude information from the devices dv2 to dv5 to the processing device 20, the processing device 20 can create a three-dimensional map.

### Fourth Embodiment

In the first to third embodiments described above, a method of performing positioning of one or a plurality of devices has been described. Hereinafter, a specific application example will be described.

FIG. 16 is a plan layout view illustrating an example in which beacon devices are installed at a plurality of locations in a room. The black triangle mark in FIG. 16 indicates a reference beacon device 39a whose installation position is fixed. The outlined triangle mark indicates a beacon device 39b whose installation place can be changed. In the present embodiment, even if the installation location of the beacon device 39b is changed, by reciprocating signals between the beacon devices 39b or between the beacon device 39b and the reference beacon device 39a, the position of each beacon device 39b can be detected using the distance information calculated on the basis of propagation channel characteristics.

The position of each beacon device 39b can be detected by the processing device 20 such as a server that acquires distance information and altitude information from each beacon device 39a and each reference beacon device 39b.

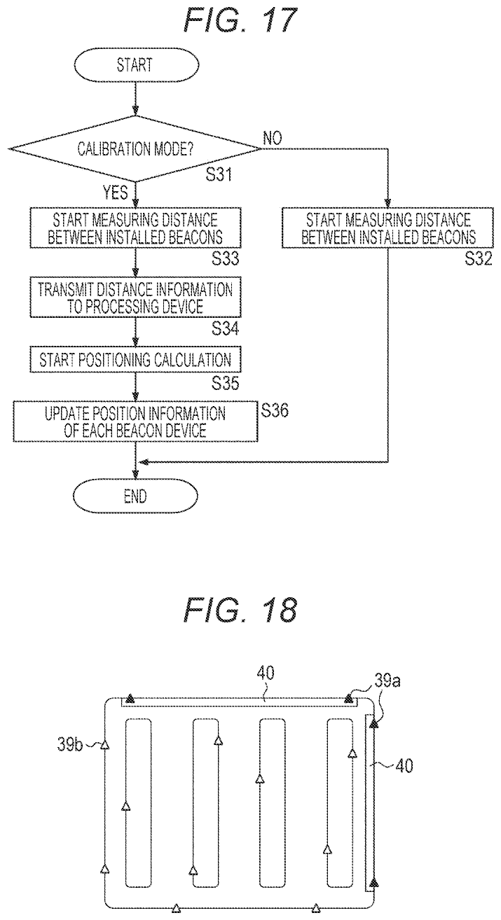

FIG. 17 is a flowchart illustrating a first example of a processing operation of a communication system according to a fourth embodiment. First, it is determined whether or not the mode is a calibration mode (step S31). The calibration mode refers to a mode in which the processing device 20 performs a process of updating the position of each beacon device 39b. The processing device 20 may shift to the calibration mode when the power is turned on or reset, may shift to the calibration mode when an explicit instruction is given from a user, or may shift to the calibration mode at predetermined time intervals or irregularly.

If it is determined in step S31 that the mode is not the calibration mode, each beacon device 39b and the processing device 20 operate in a normal mode (step S32). The normal mode is a mode of calculating or acquiring distance information with a moving object.

If it is determined in step S31 that the mode is the calibration mode, signals are reciprocated between the individual beacon devices 39b or between the beacon device 39b and the reference beacon device 39a to start distance measurement, and relative distance information is calculated on the basis of the propagation channel characteristics (step S33). The distance information calculated is transmitted to the processing device 20 (step S34). In addition, in a case where each beacon device 39b includes the altitude sensor 10, altitude information is transmitted to the processing device 20.

Next, the processing device 20 starts positioning calculation of each beacon device 39b on the basis of the distance information and the altitude information (step S35). The processing device 20 updates the position information of each beacon device 39b on the basis of the result of the positioning calculation (step S36).

When the position information of each beacon device 39b is updated, updated coordinate information may be directly transmitted to each beacon device 39b, or the processing device 20 may have a database in which the position (coordinate) information of each beacon device 39b is registered, and the processing device 20 may manage the position of each beacon device 39b.

Furthermore, each beacon device 39b may transmit information other than the distance information and the altitude information, for example, battery remaining amount information, to the processing device 20. In a case where each beacon device 39b transmits the battery remaining amount information to the processing device 20, the processing device 20 can manage the battery state of each beacon device 39b, and prompt an operator or the like to replace the battery before the battery runs out.

Although FIG. 16 illustrates an example in which the reference beacon device 39a whose installation place is fixed is provided, the reference beacon device 39a may acquire absolute position (coordinate) information. It is difficult to acquire a GPS signal indoors, but it is often possible to acquire a GPS signal at a window. Therefore, as illustrated in FIG. 18, the reference beacon device 39a may be installed near a window 40 to acquire the absolute position information. If the reference beacon device 39a capable of acquiring the absolute position information is included among the plurality of beacon devices 39b and the reference beacon device 39a, all the beacon devices 39b and the reference beacon device 39a can acquire the absolute position information.

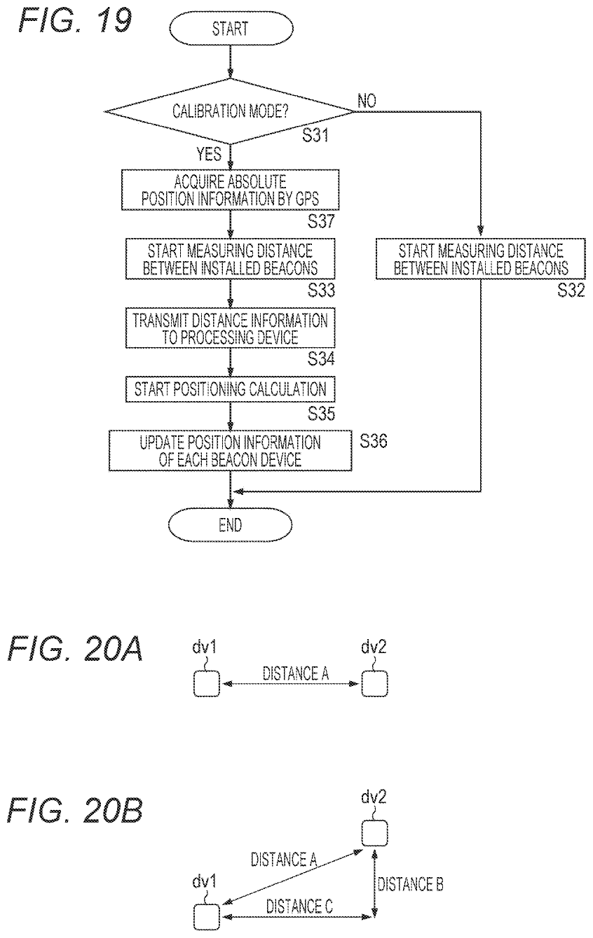

FIG. 19 is a flowchart illustrating a second example of the processing operation of the communication system according to the fourth embodiment. The flowchart of FIG. 19 is obtained by adding step S37 to the flowchart of FIG. 17. Step S37 is performed when it is determined in step S31 that the mode is the calibration mode. In step S37, the reference beacon device 39a receives a GPS signal and acquires absolute position information. Thereafter, by performing the processes of steps S33 to S36, the processing device 20 can update the absolute position information of each beacon device 39b.

As described above, in the fourth embodiment, by reciprocating signals between the plurality of beacon devices 39b and transmitting the distance information calculated on the basis of the propagation channel characteristics to the processing device 20, the processing device 20 can update the position of each beacon device 39b.

### Fifth Embodiment

In a fifth embodiment, the reliability of a calculated value of distance information is evaluated.

FIG. 20A illustrates an example in which the device dv1 and the device dv2 are provided at the same altitude, and FIG. 20B illustrates an example in which the device dv1 and the device dv2 are provided at different altitudes. For example, in FIG. 20A, it is assumed that a distance A between the devices dv1 and dv2 is calculated to be 5 m. In addition, in FIG. 20B, it is assumed that the distance A is calculated to be 5 m and an altitude difference B is detected to be 3 m by the altitude sensor 10. In this case, a horizontal distance C between the device dv1 and the device dv2 is calculated to be 4 m by the three-square theorem.

As described above, if height information can be obtained, the angle and the horizontal distance can be obtained only by two devices. The reliability of calculation of distance information can be set using these pieces of information.

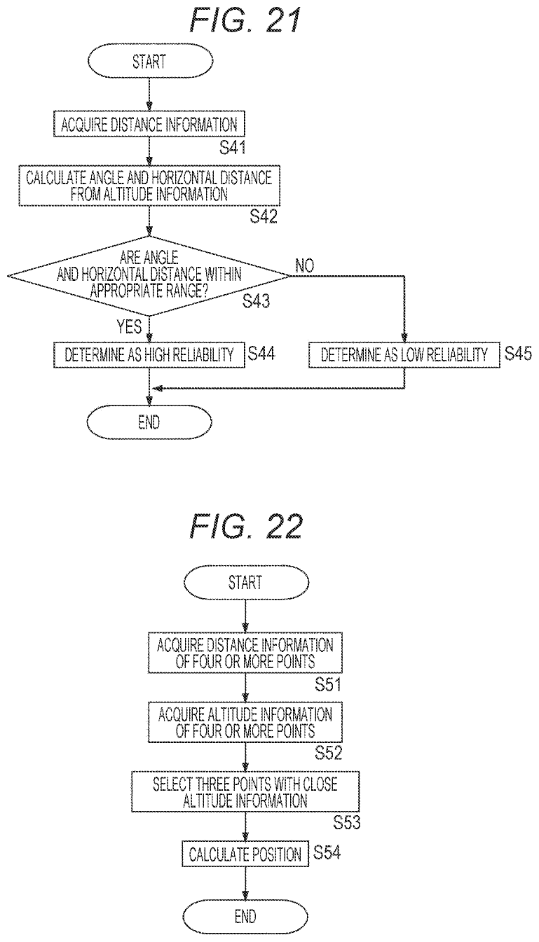

FIG. 21 is a flowchart illustrating a first example of a processing operation of a communication system according to the fifth embodiment. This flowchart is performed by, for example, the processing device 20 such as a server.

First, for example, distance information is acquired on the basis of propagation channel characteristics by reciprocating signals between a plurality of devices (step S41). Next, altitude information from each device is acquired, and the angle formed by and the horizontal distance between the two devices are calculated on the basis of the altitude information acquired and the distance information acquired (step S42).

Next, it is determined whether or not the angle and the horizontal distance calculated in step S42 are values within an appropriate range (step S43). If it is determined that the value is within the appropriate range, it is determined that the distance information acquired has high reliability (step S44). On the other hand, if it is determined that the value is out of the appropriate range, it is determined that the distance information acquired has low reliability (step S45).

For example, in a case where the height is detected to be 3 m by the altitude sensor 10 but the distance information calculated is within 3 m, the horizontal distance is equal to or less than 0 m, and thus it is determined that the reliability is low. In addition, in a case where the angle is calculated to be 90 degrees even though a plurality of devices is not arranged in a vertical direction, it is also determined that the reliability is low.

In this manner, by handling the altitude information as known information with high accuracy, the validity of the distance information calculated on the basis of the propagation channel characteristics can be easily and accurately determined.

FIG. 22 is a flowchart illustrating a second example of the processing operation of the communication system according to the fifth embodiment. This flowchart is also performed by, for example, the processing device 20 such as a server. First, distance information of four or more points is acquired (step S51). Next, altitude information of four or more points is acquired (step S52). Next, among pieces of the altitude information acquired in step S52, three points with close altitude information are selected (step S53). Next, a position is calculated on the basis of the distance information of four or more points and the altitude information of the selected three points (step S54).

In step S53, three points with close altitude information are selected from a large number of pieces of altitude information. This is because the closer the altitude values are, the larger the ratio of the horizontal distance to the distance between two points becomes, and the distance between the two points can be calculated more accurately.

As described above, in the fifth embodiment, by using the altitude information, the reliability of the distance information calculated on the basis of the propagation channel characteristics can be easily and accurately determined.

### Sixth Embodiment

In the first to fifth embodiments described above, as a specific method of calculating distance information on the basis of propagation channel characteristics, the method of calculating the distance information by the phase-based method has been mainly described. However, the distance information may be calculated by a method other than the phase-based method. For example, it is also conceivable to calculate distance information using UWB. In the UWB, a predetermined frequency range is divided into a plurality of sub-bands, a multi-band signal is transmitted in each sub-band, and the propagation delay time of a signal between the transmission unit 3 and the reception unit 4 is estimated. The distance between the transmission unit 3 and the reception unit 4 can be calculated from the propagation delay time.

Note that the present technology can have the following configurations.

(1) A communication device including a distance acquisition unit that acquires distance information calculated on the basis of a propagation channel characteristic, and

an altitude acquisition unit that acquires altitude information.

(2) The communication device according to (1), further including a communication unit that transmits the distance information and the altitude information to a processing device.

(3) The communication device according to (1) or (2), in which the distance acquisition unit acquires the distance information calculated from a relationship between each frequency and each phase of a plurality of propagation channels.

(4) The communication device according to (1) or (2), in which the distance acquisition unit directly acquires the distance information from a measured phase calculated on the basis of a group delay calculated from a relationship between each frequency and each phase of a plurality of propagation channels.

(5) The communication device according to (1) or (2), in which the distance acquisition unit acquires the distance information on the basis of a wireless signal in an ultra wideband (UWB) band.

(6) The communication device according to (3) to (5), in which the altitude acquisition unit acquires the altitude information on the basis of an atmospheric pressure detected by an atmospheric pressure sensor.

(7) The communication device according to (6), in which the altitude acquisition unit acquires the altitude information on the basis of an atmospheric pressure detected by the atmospheric pressure sensor and a temperature detected by a temperature sensor.

(8) A processing device including a distance acquisition unit that acquires a plurality of pieces of distance information calculated from a relationship between each frequency and each phase of a plurality of propagation channels,

an altitude acquisition unit that acquires altitude information through communication, and

a position detection unit that detects position information on the basis of the distance information and the altitude information.

(9) The processing device according to (8), in which the distance acquisition unit acquires three or more pieces of the distance information related to distances between an object and three or more communication partner devices, and the position detection unit detects a position of

the object on the basis of the three or more pieces of distance information and the altitude information.

(10) The processing device according to (9), in which the altitude acquisition unit acquires three or more pieces of the altitude information from the three or more communication partner devices, and

the position detection unit detects a position of the object on the basis of the three or more pieces of distance information and the three or more pieces of altitude information.

(11) The processing device according to (10), in which by the object transmitting and receiving wireless signals of a plurality of frequencies to and from the three or more communication partner devices to calculate a phase, the distance acquisition unit calculates distance information with the three or more communication partner devices in the object, and

the position detection unit detects a position of the object on the basis of three or more pieces of the distance information calculated by the distance acquisition unit and the three or more pieces of altitude information.

(12) The processing device according to (10), in which the distance acquisition unit acquires the three or more pieces of distance information calculated in the three or more communication partner devices by the object communicating with the three or more communication partner devices, and

the position detection unit detects a position of the object on the basis of the three or more pieces of distance information acquired by the distance acquisition unit and the three or more pieces of altitude information.

(13) The processing device according to (11) or (12), in which the position detection unit creates a three-dimensional map indicating position information in a predetermined three-dimensional space on the basis of the distance information.

(14) The processing device according to (13), in which the distance acquisition unit acquires three or more pieces of the distance information between an object and three or more communication partner devices, and

the position detection unit creates the three-dimensional map on the basis of the three or more pieces of distance information.

(15) The processing device according to (14), in which the three-dimensional map includes position information of the object and the three or more communication partner devices.

(16) The processing device according to (15), in which the distance acquisition unit acquires three or more pieces of the distance information related to distances between an object and three or more communication partner devices,

the altitude acquisition unit acquires three or more pieces of the altitude information from the three or more communication partner devices, and

the position detection unit creates the three-dimensional map on the basis of the three or more pieces of distance information and the three or more pieces of altitude information.

(17) A processing device including a distance acquisition unit that acquires a plurality of pieces of distance information calculated from a relationship between each frequency and each phase of a plurality of propagation channels,

a position acquisition unit that acquires absolute position information of at least one point, and

a position information detection unit that detects position information on the basis of the plurality of pieces of distance information and absolute position information acquired by the position acquisition unit.

(18) The processing device according to (17), in which the position acquisition unit acquires the absolute position information regularly or irregularly, and

the position detection unit updates the position information on the basis of the absolute position information regularly or irregularly acquired by the position acquisition unit.

(19) The processing device according to (17) or (18), further including an altitude acquisition unit that acquires altitude information through communication, in which

the position detection unit detects the position information on the basis of the plurality of pieces of distance information, the absolute position information, and the altitude information.

(20) The processing device according to (19), in which the altitude information includes altitude difference information related to an altitude difference between two points, and

the processing device further including a reliability estimation unit that estimates reliability of the distance information on the basis of the distance information and the altitude difference information.

(21) The communication device according to any one of (3) to (5), further including a position acquisition unit that acquires absolute position information of at least one point.

(22) The communication device according to (21), in which the position acquisition unit acquires global positioning system (GPS) information.

(23) A communication system including

a first communication device,

a second communication device that transmits and receives a wireless signal to and from the first communication device,

a distance acquisition unit that acquires distance information calculated on the basis of a propagation channel characteristic,

an altitude acquisition unit that acquires altitude information, and

a position detection unit that detects position information on the basis of the distance information and the altitude information.

(24) The communication system according to (23), further including a third communication device that transmits and receives a wireless signal to and from the second communication device, in which

the second communication device includes the distance acquisition unit and the altitude acquisition unit,

the third communication device includes the position detection unit,

the distance acquisition unit acquires the distance information with the first communication device, and

the position detection unit detects the position information on the basis of the distance information and the altitude information.

(25) A communication method including acquiring distance information calculated on the basis of a propagation channel characteristic,

acquiring altitude information, and

detecting position information on the basis of the distance information and the altitude information.

Aspects of the present disclosure are not limited to the individual embodiments described above, but include various modifications that can be conceived by those skilled in the art, and the effects of the present disclosure are not limited to the contents described above. That is, various additions, modifications, and partial deletions can be made without departing from the conceptual idea and spirit of the present disclosure derived from the contents defined in the claims and equivalents thereof.

### REFERENCE SIGNS LIST

1 Communication device
2 Antenna
3 Transmission unit
4 Reception unit
5 Distance acquisition unit
6 Altitude acquisition unit
7 Clock generator
8 Distance calculation unit
9 Altitude calculation unit
10 Altitude sensor
11 Initiator
12 Reflector
13 Control unit
20 Processing device
30 Interface unit
31 Low noise amplifier
32 Mixer
33 Band pass filter
34 Variable gain amplifier
35 BPF
36 VGA
37 ADC
41 Phase measurement unit
43 RAM
44 Automatic gain control unit
61 Distance acquisition unit
62 Position detection unit

1. A communication device comprising:
a distance acquisition unit that acquires distance information calculated on a basis of a propagation channel characteristic; and
an altitude acquisition unit that acquires altitude information.

2. The communication device according to claim 1, further comprising a communication unit that transmits the distance information and the altitude information to a processing device.

3. The communication device according to claim 2, wherein the distance acquisition unit acquires the distance information calculated from a relationship between each frequency and each phase of a plurality of propagation channels.

4. The communication device according to claim 3, wherein the distance acquisition unit directly acquires the distance information from a measured phase calculated on a basis of a group delay calculated from a relationship between each frequency and each phase of a plurality of propagation channels.

5. The communication device according to claim 2, wherein the distance acquisition unit acquires the distance information on a basis of a wireless signal in an ultra wideband (UWB) band.

6. The communication device according to claim 3, wherein the altitude acquisition unit acquires the altitude information on a basis of an atmospheric pressure detected by an atmospheric pressure sensor.

7. The communication device according to claim 6, wherein the altitude acquisition unit acquires the altitude information on a basis of an atmospheric pressure detected by the atmospheric pressure sensor and a temperature detected by a temperature sensor.

8. A processing device comprising:
a distance acquisition unit that acquires a plurality of pieces of distance information calculated from a relationship between each frequency and each phase of a plurality of propagation channels;
an altitude acquisition unit that acquires altitude information through communication; and
a position detection unit that detects position information on a basis of the distance information and the altitude information.

9. The processing device according to claim 8, wherein
the distance acquisition unit acquires three or more pieces of the distance information related to distances between an object and three or more communication partner devices, and
the position detection unit detects a position of the object on a basis of the three or more pieces of distance information and the altitude information.

10. The processing device according to claim 9, wherein
the altitude acquisition unit acquires three or more pieces of the altitude information from the three or more communication partner devices, and
the position detection unit detects a position of the object on a basis of the three or more pieces of distance information and the three or more pieces of altitude information.

11. The processing device according to claim 10, wherein
by the object transmitting and receiving wireless signals of a plurality of frequencies to and from the three or more communication partner devices to calculate a phase, the distance acquisition unit calculates distance information with the three or more communication partner devices in the object, and
the position detection unit detects a position of the object on a basis of three or more pieces of the distance information calculated by the distance acquisition unit and the three or more pieces of altitude information.

12. The processing device according to claim 10, wherein
the distance acquisition unit acquires the three or more pieces of distance information calculated in the three or more communication partner devices by the object communicating with the three or more communication partner devices, and
the position detection unit detects a position of the object on a basis of the three or more pieces of distance information acquired by the distance acquisition unit and the three or more pieces of altitude information.

13. The processing device according to claim 12, wherein the position detection unit creates a three-dimensional map indicating position information in a predetermined three-dimensional space on a basis of the distance information.

14. The processing device according to claim 13, wherein
the distance acquisition unit acquires three or more pieces of the distance information between an object and three or more communication partner devices, and
the position detection unit creates the three-dimensional map on a basis of the three or more pieces of distance information.

15. The processing device according to claim 14, wherein the three-dimensional map includes position information of the object and the three or more communication partner devices.

16. The processing device according to claim 15, wherein
the distance acquisition unit acquires three or more pieces of the distance information related to distances between an object and three or more communication partner devices,
the altitude acquisition unit acquires three or more pieces of the altitude information from the three or more communication partner devices, and
the position detection unit creates the three-dimensional map on a basis of the three or more pieces of distance information and the three or more pieces of altitude information.

17. A processing device comprising:
a distance acquisition unit that acquires a plurality of pieces of distance information calculated from a relationship between each frequency and each phase of a plurality of propagation channels;
a position acquisition unit that acquires absolute position information of at least one point; and
a position detection unit that detects position information on a basis of the plurality of pieces of distance information and absolute position information acquired by the position acquisition unit.

18. The processing device according to claim 17, wherein the position acquisition unit acquires the absolute position information regularly or irregularly, and
the position detection unit updates the position information on a basis of the absolute position information regularly or irregularly acquired by the position acquisition unit.

19. The processing device according to claim 17, further comprising an altitude acquisition unit that acquires altitude information through communication, wherein
the position detection unit detects the position information on a basis of the plurality of pieces of distance information, the absolute position information, and the altitude information.

20. The processing device according to claim 19, wherein
the altitude information includes altitude difference information related to an altitude difference between two points, and
the processing device further comprises a reliability estimation unit that estimates reliability of the distance information on a basis of the distance information and the altitude difference information.

21. The communication device according to claim 3, further comprising a position acquisition unit that acquires absolute position information of at least one point.

22. The communication device according to claim 21, wherein the position acquisition unit acquires global positioning system (GPS) information.

23. A communication system comprising:
a first communication device;
a second communication device that transmits and receives a wireless signal to and from the first communication device;
a distance acquisition unit that acquires distance information calculated on a basis of a propagation channel characteristic;
an altitude acquisition unit that acquires altitude information; and
a position detection unit that detects position information on a basis of the distance information and the altitude information.

24. The communication system according to claim 23, further comprising a third communication device that transmits and receives a wireless signal to and from the second communication device, wherein
the second communication device includes the distance acquisition unit and the altitude acquisition unit,
the third communication device includes the position detection unit,
the distance acquisition unit acquires the distance information with the first communication device, and
the position detection unit detects the position information on a basis of the distance information and the altitude information.

25. A communication method comprising:
acquiring distance information calculated on a basis of a propagation channel characteristic;
acquiring altitude information; and
detecting position information on a basis of the distance information and the altitude information.
